(19) United States
(12) Patent Application Publication
(10) Pub. No.: US 2004/0166369 A1
(43) Pub. Date: Aug. 26, 2004

(54) High saturation flux density soft magnetic film

(75) Inventors: Kazuhiko Shintaku, Akita-shi (JP); Kiyoshi Yamakawa, Akita-shi (JP); Kazuhiro Ouchi, Minamiakita-gun (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Akita Prefecture

(21) Appl. No.: 10/789,101

(22) Filed: Feb. 27, 2004

Related U.S. Application Data
(63) Continuation of application No. PCT/JP03/05847, filed on May 9, 2003.

(30) Foreign Application Priority Data
May 10, 2002 (JP) 2002-136065

(51) Int. Cl. B32B 19/00

(52) U.S. Cl. 428/692

(57) ABSTRACT

A high saturation flux density soft magnetic film substantially consists of an FeₓCo₁₋ₓ alloy (0.65≦x≦0.75) containing 3% or less of Al₂O₃.

### CROSS-REFERENCE TO RELATED APPLICATIONS

This is a Continuation Application of PCT Application No. PCT/JP03/05847, filed May 9, 2003, which was not published under PCT Article 21(2) in English.

This application is based upon and claims the benefit of priority from prior Japanese Patent Application No. 2002-136065, filed May 10, 2002, the entire contents of which are incorporated herein by reference.

### BACKGROUND OF THE INVENTION

1. Field of the Invention

The present invention relates to a high saturation flux density soft magnetic film, in particular, to a high saturation flux density soft magnetic film that can be suitably used as a core material of a magnetic recording head capable of coping with a recording medium with a high coercivity.

2. Description of the Related Art

With the increase of capacity and recording speed for information recording, prominent progress has been achieved in information storage devices in recent years. In particular, a hard disc having a high capacity and a high recording speed, excellent in reliability, and capable of overwriting information has established a firm position as an information storage device. However, with the increase of recording density derived from the increase of capacity, the coercivity of a recording medium tends to be increased. Thus, a soft magnetic film with a high saturation flux density is required for a core material of the magnetic head for recording information on the recording medium with such a high coercivity.

A high saturation flux density is required first for the soft magnetic film used for a magnetic head core material. Recently, a soft magnetic film with a saturation flux density more than 2.2 T is being vigorously studied. FeₓCo₁₋ₓ (0.65≦x≦0.75) is promising as a material exhibiting such a high saturation flux density. It is known that the FeCo alloy of the particular composition exhibits a high saturation flux density of 2.4 T or more. However, where the FeCo alloy of the particular composition is formed into a thin film by an ordinary sputtering method, the thin film exhibits a coercivity of 50 to 100 Oe, which makes it impossible to use the thin film as the core material of the magnetic head.

Therefore, it is important to decrease the coercivity in the hard axis direction without greatly decreasing the saturation flux density of the FeCo alloy.

In order to decrease the coercivity of the FeCo alloy, conventionally known is a method in which an alloy target formed of FeCo and a third component added thereto or a composite formed of an FeCo target and a chip of a third component disposed thereon is used and reactive sputtering is carried out in argon gas containing about several percent of additive gas such as nitrogen gas or oxygen gas. The third component is of a material that is likely to bond selectively with the additive gas and serves to prevent Fe or Co from being affected by the additive gas. In this method, however, it was impossible to obtain satisfactory soft magnetic characteristics unless 5% or more of the third component other than FeCo is added. Under the circumstances, the deposited film inevitably had a markedly decreased saturation flux density.

Further, the domain control of the recording head has also become important and, thus, a high anisotropy field has come to be required.

In addition to the improvement in the magnetic characteristics described above, it is preferable that stable magnetic characteristics can be provided over a wide range of film thickness in order to facilitate the design of the magnetic head.

### BRIEF SUMMARY OF THE INVENTION

An object of the present invention is to provide a high saturation flux density soft magnetic film with a high saturation flux density, a low coercivity, and a high anisotropy field.

A high saturation flux density soft magnetic film according to the present invention substantially consists of an FeₓCo₁₋ₓ alloy (0.65≦x≦0.75) containing 3% or less of Al₂O₃.

The high saturation flux density soft magnetic film according to the present invention preferably has a thickness in the range of 100 nm to 1,000 nm.

### BRIEF DESCRIPTION OF THE SEVERAL VIEWS OF THE DRAWING

FIG. 1 is a graph showing the magnetization curve of a FeCo-based film containing Al₂O₃ in Example 1;

FIG. 2 is a graph showing the magnetization curve of a FeCo-based film not containing Al₂O₃ in Comparative Example;

FIG. 3 is a graph showing film thickness dependence of the coercivity in the hard axis direction with respect to the FeCo-based films containing Al₂O₃ in Example 2; and

FIG. 4 is a graph showing Al₂O₃ content dependence of the saturation flux density and the coercivity in the hard axis direction with respect to the FeCo-based films containing Al₂O₃ in Example 3.

### DETAILED DESCRIPTION OF THE INVENTION

The high saturation flux density soft magnetic film according to the present invention will now be described in detail.

The high saturation flux density soft magnetic film according to the present invention contains FeₓCo₁₋ₓ (0.65≦x≦0.75) as a main component. It is known that the saturation flux density of an FeCo alloy with an appropriate composition can be increased to reach 2.45 T, which is the highest value obtained in the alloy system, by adjusting a sputtering target, deposition conditions, and so on. The FeCo alloy in a composition range represented by FeₓCo₁₋ₓ (0.65≦x≦0.75) exhibits a saturation flux density close to the value noted above.

The high saturation flux density soft magnetic film according to the present invention has composition in which 3% or less of Al₂O₃ is added to FeₓCo₁₋ₓ (0.65≦x≦0.75). The Al₂O₃ content preferably falls within the range of 0.5% to 3%.

The high saturation flux density soft magnetic film with such composition exhibits a high saturation flux density and satisfactory soft magnetic characteristics, i.e., a saturation flux density of 2.37 T or more, a coercivity in the hard axis direction of 5 Oe or less, and an anisotropy field of 20 Oe or more. If the Al₂O₃ content is less than 0.5%, the coercivity in the hard axis direction tends to be increased. If the Al₂O₃ content exceeds 3%, the saturation flux density tends to be decreased.

Since the high saturation flux density soft magnetic film of the present invention exhibits a high saturation flux density, where the film is used as a core material of the magnetic recording head, it makes easy to write information to a recording medium with a high coercivity and it is also possible to form stable magnetic domains in the recording medium so as to improve the quality of reproduction signals.

The reason why the high saturation flux density soft magnetic film according to the present invention should preferably have a thickness in the range of 100 nm to 1,000 nm is as follows. That is, if the thickness of the film falls within the range noted above, the coercivity in the hard axis direction is decreased to 5 Oe or less. Since desired magnetic characteristics can be obtained over such a wide range of the film thickness, it is also possible to increase a design margin and a manufacturing margin of the magnetic head.

The high saturation flux density soft magnetic film according to the present invention can be deposited by a sputtering method. To be more specific, it is possible to employ any of methods given below:

1) Sputtering is performed by using a sintered target of an FeCo alloy containing 3% or less of Al₂O₃.

2) Co-sputtering is performed by using an FeCo alloy target and an Al₂O₃ target.

3) Sputtering is performed by using a composite target formed of an FeCo alloy target and an Al₂O₃ chip disposed thereon.

Incidentally, in the high saturation flux density soft magnetic film according to the present invention, it is possible that the Al—O component deviates from the stoichiometric composition depending on manufacturing conditions. That is, although the high saturation flux density soft magnetic film according to the present invention must be represented by the formula (FeₓCo₁₋ₓ)_{y}(Al₂O₃)_{1-y} in view of the target composition, it is possible that the film actually deposited may have a composition represented by the formula:

(FeₓCo₁₋ₓ)_{y}(Al₂O_{z})_{1-y}

(where 0.65≦x≦0.75, 0≦1-y≦0.03, and 1≦z≦8).

If the sputtering conditions are once determined, a high saturation flux density soft magnetic film with desired magnetic characteristics can be stably manufactured thereafter.

### EXAMPLES

### Example 1

A high saturation flux density soft magnetic film was formed on a substrate as follows.

A sintered body of (Fe_{0.70}CO_{0.30})_{0.99}(Al₂O₃)_{0.01} having a disc shape of a diameter of 100 mm and a thickness of 3 mm was used as a target. A silicon substrate of 10 mm square and 1 mm thick and having a silicon oxide film formed on the surface thereof was used as a substrate.

The target and the substrate were fixed about 75 mm apart from each other in the vacuum chamber of a six-target radio frequency magnetron sputtering apparatus (SPM-506 manufactured by Tokki Corporation). Also, in order to impart magnetic anisotropy to the soft magnetic film, a magnetic field more than 100 Oe was applied to the central portion of the substrate by using a permanent magnet.

The vacuum chamber was exhausted to 2×10⁻⁵ Pa. Then, Ar gas was introduced into the vacuum chamber, and the gas flow rate was controlled to set up a pressure of 1 Pa. Radio frequency sputtering was performed under a discharge power of 400 W and a discharge frequency of 13.56 MHz so as to deposit an FeCo-based film containing Al₂O₃ in a thickness of about 400 nm on the substrate.

As a comparative example, an Fe₇₀CO₃₀ alloy target not containing Al₂O₃ was prepared, and an FeCo-based film was deposited in a thickness of about 400 nm on the substrate by the procedures similar to those described above.

The characteristics of the FeCo-based films thus obtained were evaluated. A vibrating sample magnetometer (VSM) was used for the measurements.

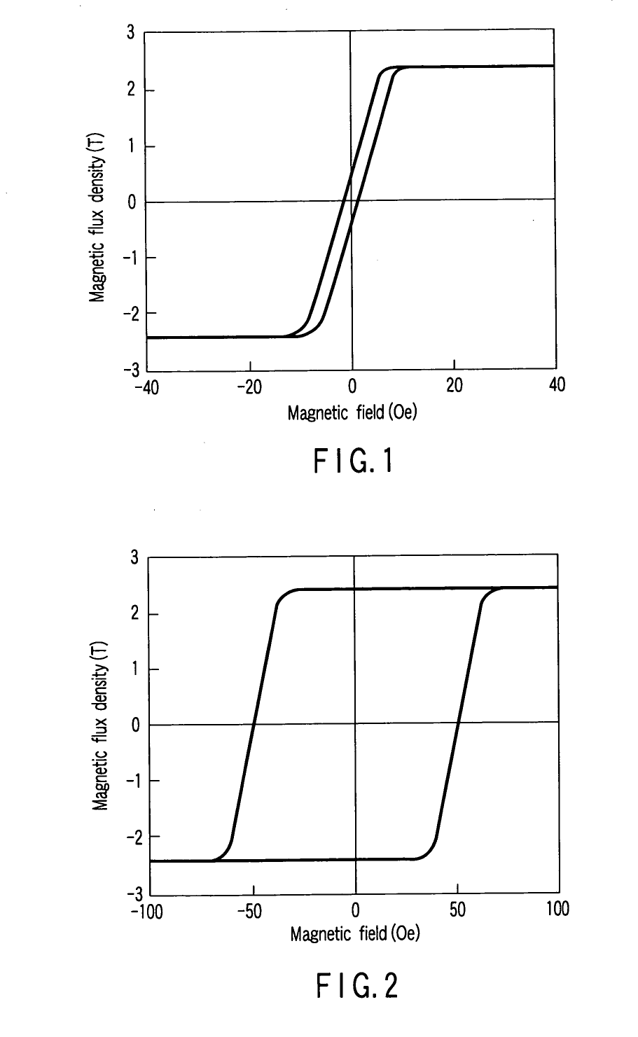

FIG. 1 shows a typical magnetization curve of an FeCo-based film containing Al₂O₃. The saturation flux density was 2.42 T, the coercivity in the hard axis direction was 3 Oe and the anisotropy field was 23 Oe, which exhibit a high saturation flux density and satisfactory soft magnetic characteristics.

FIG. 2 shows a typical magnetization curve of an FeCo-based film not containing Al₂O₃. The saturation flux density was 2.45 T and the coercivity in the hard axis direction was 50 Oe.

From the results of FIGS. 1 and 2, it is found that the soft magnetic characteristics can be markedly improved by adding a very small amount of Al₂O₃ to the FeCo alloy.

### Example 2

FeCo-based films containing Al₂O₃ were deposited in various thicknesses on substrates by the procedures similar to those in Example 1.

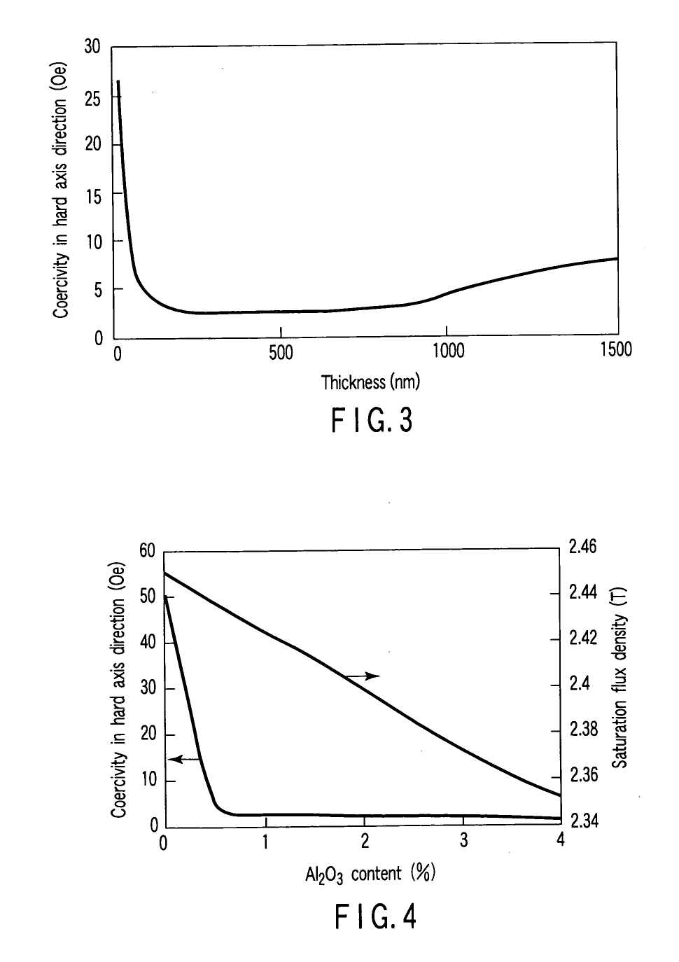

FIG. 3 shows the film thickness dependence of the coercivity in the hard axis direction with respect to the FeCo-based films containing Al₂O₃. It can be judged from FIG. 3 that, if the film thickness falls within the range of 100 nm to 1,000 nm, the coercivity in the hard axis direction is less than 5 Oe.

Also, the saturation flux density was substantially constant, i.e., 2.42 T, and the anisotropy field was more than 20 Oe in all the FeCo-based films within the range shown in FIG. 3.

### Example 3

FeCo-based films containing various amounts of Al₂O₃ were deposited on substrates by the procedures similar to those in Example 1, except that sintered bodies of (Fe_{0.70}Cu0.30)_{y}(Al₂O₃)_{1-y} (0.005≦1-y≦0.04) differing from each other in the Al₂O₃ content were used as the targets.

FIG. 4 shows the Al₂O₃ content dependence of the saturation flux density and the coercivity in the hard axis direction with respect to the FeCo-based films. It can be judged from FIG. 4 that, if the Al₂O₃ content falls within the range of 0.5% to 3%, the saturation flux density is more than 2.37 T, and the coercivity in the hard axis direction is less than 5 Oe.

Also, the anisotropy field was more than 20 Oe in all the FeCo-based films within the range shown in FIG. 4.

Incidentally, the description given above covers the case where 3% or less of Al₂O₃ is added to FeₓCo₁₋ₓ (0.65≦x≦0.75). However, it is also conceivable to use SiO₂, MgO or Ti—O as an additive compound in place of Al₂O₃.

As described above in detail, since the high saturation flux density soft magnetic film according to the present invention has a high saturation flux density, in the case where the film is used as a core material of the magnetic recording head, it is possible to write information easily to a recording medium with a high coercivity and it is also possible to form stable magnetic domains in the recording medium so as to improve the quality of reproduction signals. Furthermore, since desired magnetic characteristics can be obtained over a wide range of film thickness, it is possible to increase a design margin and a manufacturing margin of the magnetic head.

What is claimed is:

1. A high saturation flux density soft magnetic film substantially consisting of an FeₓCo₁₋ₓ alloy (0.65≦x≦0.75) containing 3% or less of Al₂O₃.

2. The high saturation flux density soft magnetic film according to claim 1, wherein the film has a thickness in a range of 100 nm to 1,000 nm.
